(19) United States
(12) Patent Application Publication
(10) Pub. No.: US 2024/0354616 A1
(43) Pub. Date: Oct. 24, 2024

(54) DISTRIBUTED MICROWAVE QUANTUM COMPUTING SYSTEM

(71) Applicant: Anyon Computing Inc., Emeryville, CA (US)

(72) Inventors: Jie Luo, Emeryville, CA (US); Xinyu Liu, Emeryville, CA (US); Hengjiang Ren, Emeryville, CA (US)

(21) Appl. No.: 18/137,016

(22) Filed: Apr. 20, 2023

Related U.S. Application Data
(60) Provisional application No. 63/333,225, filed on Apr. 21, 2022.

(51) Int. Cl. G06N 10/40; B82Y 10/00; B82Y 20/00; G06N 10/20

(52) U.S. Cl. CPC G06N 10/40; B82Y 10/00; B82Y 20/00; G06N 10/20

(57) ABSTRACT

A quantum node includes one or more communication qubits, one or more interior qubits coupled to the one or more communication qubits with interior tunable couplers, a communication tunable coupler coupled to each of the one or more communication qubits, and a communication resonator coupled to each of the communication tunable couplers. In addition, a distributed quantum computing system includes two or more quantum nodes, and one or more coaxial cables or coplanar waveguides connecting the two or more quantum nodes together using at least one of the communication resonators of the two or more quantum nodes. Entanglement and fabrication methods of the quantum nodes are also described.

### CROSS-REFERENCE TO RELATED APPLICATIONS

This application claims priority to U.S. Provisional Application Ser. No. 63/333,225 filed Apr. 21, 2022 entitled “Distributed Microwave Quantum Computing System”. The entire contents of the foregoing application is incorporated herein by reference.

### STATEMENT OF FEDERALLY FUNDED RESEARCH

Not applicable.

### TECHNICAL FIELD OF THE INVENTION

The present invention relates in general to semiconductor processing and computer processors. In particular, the present invention relates to a distributed microwave quantum computing system.

### BACKGROUND OF THE INVENTION

Previous experimental efforts only demonstrate entanglement generation between two superconducting quantum processors (quantum nodes) and not scalable to multi-node entanglement between more than two quantum processors. (References #1-4 below).

As a result, there is a need for a quantum computing system that provides entanglement for more than two quantum procesors.

### SUMMARY OF THE INVENTION

The various embodiments described herein are scalable beyond two quantum nodes as the architecture is self-similar and entanglement can be generated in a large multi-node entanglement network at high fidelity by concatenation. These methods also eliminate the use of single-photon-detectors in between to generate heralding. These methods only require heralding detection to happen within computational quantum nodes. This further improves the scalability and entanglement fidelity unseen in any prior works.

In one embodiment of the present disclosure, a quantum node includes one or more communication qubits, one or more interior qubits coupled to the one or more communication qubits with interior tunable couplers, a communication tunable coupler coupled to each of the one or more communication qubits, and a communication resonator coupled to each of the communication tunable couplers.

In one aspect, the one or more interior qubits comprise a set of series connected qubits, a set of parallel connected qubits, or an array of interconnected qubits. In another aspect, a readout resonator is coupled to each of the one or more communication qubits and the one or more interior qubits. In another aspect, the readout resonator is used for projective measurement to implement heralding-based entanglement. In another aspect, a control connector is coupled to each of the interior tunable couplers and the communication tunable couplers. In another aspect, an alternating current or radio frequency (AC/RF) signal is applied to the interior tunable coupler or the communication tunable coupler via the control connector to cause parametric photon swap. In another aspect, a controller is coupled to the control connector, wherein the controller generates the AC/RF signal. In another aspect, a drive connector coupled to each of the one or more communication qubits and the one or more interior qubits. In another aspect, the communication resonator allows definition of a communication channel for high efficiency photon exchange between the quantum node and other quantum nodes. In another aspect, the communication resonator enhances a parametric photon release rate via resonance enhancement and modification to an electromagnetic density of states of the communication channel. In another aspect, the one or more communication qubits simultaneously release into a frequency band in the communication channel. In another aspect, the communication resonator limits noise from propagating into the quantum node from a coaxial cable or coplanar waveguide. In another aspect, an effective loss of photon transfer into or out of the quantum node is reduced using a dark mode. In another aspect, the communication resonator rejects an unwanted parametric sideband. In another aspect, the quantum node does not require any radio-frequency single-photon-detector nodes or radio-frequency beam-splitters.

In another embodiment of the present disclosure, a distributed quantum computing system includes two or more quantum nodes, wherein each quantum node includes one or more communication qubits, one or more interior qubits coupled to the one or more communication qubits with interior tunable couplers, a communication tunable coupler coupled to each of the one or more communication qubits, and a communication resonator coupled to each of the communication tunable couplers. One or more coaxial cables or coplanar waveguides connect the two or more quantum nodes together using at least one of the communication resonators of the two or more quantum nodes.

In one aspect, the two or more quantum nodes are different or substantially identical to one another. In another aspect, the two or more quantum nodes are superconducting quantum nodes. In another aspect, the one or more interior qubits comprise a set of series connected qubits, a set of parallel connected qubits, or an array of interconnected qubits. In another aspect, a readout resonator is coupled to each of the one or more communication qubits and the one or more interior qubits. In another aspect, the readout resonator is used for projective measurement to implement heralding-based entanglement. In another aspect, a control connector is coupled to each of the interior tunable couplers and the communication tunable couplers. In another aspect, an AC/RF signal is applied to the interior tunable coupler or the communication tunable coupler via the control connector to cause parametric photon swap. In another aspect, a controller is coupled to the control connector, wherein the controller generates the AC/RF signal. In another aspect, a drive connector is coupled to each of the one or more communication qubits and the one or more interior qubits. In another aspect, the communication resonator allows definition of a communication channel for high efficiency photon exchange between the quantum node and other quantum nodes. In another aspect, the communication resonator enhances a parametric photon release rate via resonance enhancement and modification to an electromagnetic density of states of the communication channel. In another aspect, the one or more communication qubits simultaneously release into a frequency band in the communication channel. In another aspect, the communication resonator limits noise from propagating into the two or more quantum nodes from the coaxial cable or coplanar waveguide. In another aspect, an effective loss of photon transfer into or out of the two or more quantum nodes is reduced using a dark mode. In another aspect, the communication resonator rejects an unwanted parametric sideband. In another aspect, the system does not require any radio-frequency single-photon-detector nodes or radio-frequency beam-splitters. In another aspect, the system is scalable.

In yet another embodiment of the present disclosure, a method of fabricating a quantum node includes depositing a first metal on a top of a substrate, coating the first metal with a first photoresist, selectively removing the first photoresist to leave a first pattern, etching the first metal to transfer the first pattern to the first metal to form a ground plane that will contain one or more communication qubits, one or more interior qubits, one or more interior tunable couplers, one or more communication tunable couplers, one or more communication resonators, and control lines, removing the first photoresist, depositing a second metal in a second pattern, oxidizing an outer portion of the second metal, and depositing a third metal in a third pattern. The combination of the first metal, the second metal, the oxidized outer portion of the second metal and the third metal form the one or more communication qubits, the one or more interior qubits coupled to the one or more communication qubits with the one or more interior tunable couplers, and the communication tunable coupler coupled to each of the one or more communication qubits and each of the one or more communication resonators.

In one aspect, the first metal comprises aluminum, niobium or tantalum, and the second and third metal comprise aluminum. In another aspect, the method further includes fabricating a wiring wafer containing control lines and co-planar waves, and bonding the wiring wafer to the quantum node. In another aspect, the method further includes bonding the wiring wafer to a printed circuit board.

In another embodiment of the present disclosure, a loss-resistant entanglement protocol for three or more quantum nodes includes: (a) providing the three or more quantum nodes comprising a first quantum node connected to a second quantum node with a first coaxial cable or a first coplanar waveguide, the second quantum node connected to a third quantum node with a second coaxial cable or a second coplanar waveguide, and wherein each of the first quantum node, the second quantum node and the third quantum node comprise: a first qubit, a second qubit, a third qubit, a first interior tunable coupler connected between the first qubit and the second qubit, a second interior tunable coupler connected between the second qubit and the third qubit, a first communication tunable coupler connected to the first qubit, a second communication tunable coupler connected to the third qubit, a first communication resonator coupled to the first communication tunable coupler, and a second communication resonator coupled to the second communication tunable coupler; (b) setting the third qubit of the first quantum node, a first communication channel mode, the third qubit of the second quantum node and a second communication channel mode to a 0 state, and the second qubit of the first quantum node, the first qubit of the second quantum node, the second qubit of the second quantum node and the first qubit of the third quantum node to a 1 state; (c) performing half-way of a two qubit swap between: (1) the second qubit of the first quantum node and the third qubit of the first quantum node, (2) the first coaxial cable or the first coplanar waveguide and the first qubit of the second quantum node, (3) the second qubit of the second quantum node, and (4) the second coaxial cable or the second coplanar waveguide and the first qubit of the third quantum node; (d) performing half-way of the two qubit swap between: (1) the third qubit of the first quantum node and the first coaxial cable or the first coplanar waveguide, and (2) the third qubit of the second quantum node and the second coaxial cable or the second coplanar waveguide; (e) measuring the third qubit of the first quantum node and the third qubit of the second quantum node; (f) setting the third qubit of the first quantum node and the first communication channel mode to the 0 state if the third qubit of the first quantum node was measured to be in the 1 state, and setting the third qubit of the second quantum node and the second communication channel mode to the 0 state if the third qubit of the second quantum node was measured to be in the 1 state; (g) flipping: (1) a state of the third qubit of the first quantum node if the second qubit of the first quantum node is in the 1 state, (2) a state of the first coaxial cable or the first 20) coplanar waveguide if the first qubit of the second quantum node is in the 1 state, (3) a state of the third qubit of the second quantum node if the second qubit of the second quantum node is in the 1 state, and (4) a state of the second coaxial cable or the second coplanar waveguide if the first qubit of the third quantum node is in the 1 state; (h) performing half-way of the two qubit swap between: (1) the third qubit of the first quantum node and the first coaxial cable or the first coplanar waveguide, and (2) the third qubit of the second quantum node and the second coaxial cable or the second coplanar waveguide; (i) measuring the third qubit of the first quantum node and the third qubit of the second quantum node; (j) wherein a first entanglement is established between the second qubit of the first quantum node and the first qubit of the second quantum node if the third qubit of the first quantum node was measured to be in the 1 state, and a second entanglement is established between the second qubit of the second quantum node and the first qubit of the third quantum node if the third qubit of the second quantum node was measured to be in the 1 state; (k) taking a Bell measurement of the first qubit of the second quantum node and the second qubit of the second quantum node; and (l) wherein a third entanglement is established between the second qubit of the first quantum node and the first qubit of the third quantum node.

In one aspect, (f) further comprises repeating (b), (c), (d) and (e) until the third qubit of the first quantum node and the third qubit of the second quantum node were measured to be in the 1 state in (e). In another aspect, (j) further comprises repeating (b), (c), (d), (e), (f), (g), (h) and (i) until the third qubit of the first quantum node and the third qubit of the second quantum node were measured to be in the 1 state in (e) and (i).

In yet another embodiment of the present disclosure, a loss-resistant entanglement protocol for two quantum nodes includes: (a) providing the two quantum nodes comprising a first quantum node connected to a second quantum node with a coaxial cable or a coplanar waveguide, and wherein each of the first quantum node and the second quantum node comprise: a first qubit, a second qubit, a third qubit, a first interior tunable coupler connected between the first qubit and the second qubit, a second interior tunable coupler connected between the second qubit and the third qubit, a first communication tunable coupler connected to the first qubit, a second communication tunable coupler connected to the third qubit, a first communication resonator coupled to the first communication tunable coupler, and a second communication resonator coupled to the second communication tunable coupler; (b) setting the third qubit of the first quantum node and a communication channel mode to a 0 state, and the second qubit of the first quantum node and the first qubit of the second quantum node to a 1 state; (c) performing half-way of a two qubit swap between: (1) the second qubit of the first quantum node and the third qubit of the first quantum node, and (2) the coaxial cable or the coplanar waveguide and the first qubit of the second quantum node; (d) performing half-way of the two qubit swap between the third qubit of the first quantum node and the coaxial cable or first coplanar waveguide; (e) measuring the third qubit of the first quantum node; (f) setting the third qubit of the first quantum node and the communication channel mode to the 0 state if the third qubit of the first quantum node was measured to be in the 1 state; (g) flipping: (1) a state of the third qubit of the first quantum node if the second qubit of the first quantum node is in the 1 state and (2) a state of the coaxial cable or the coplanar waveguide if the first qubit of the second quantum node is in the 1 state; (h) performing half-way of the two qubit swap between the third qubit of the first quantum node and the coaxial cable or the coplanar waveguide; (i) measuring the third qubit of the first quantum node; and (j) wherein an entanglement is established between the second qubit of the first quantum node and the first qubit of the second quantum node if the third qubit of the first quantum node was measured to be in the 1 state.

In one aspect, (f) further comprises repeating (b), (c), (d) and (e) until the third qubit of the first quantum node was measured to be in the 1 state in (e). In another aspect, (j) further comprises repeating (b), (c), (d), (e), (f), (g), (h) and (i) until the third qubit of the first quantum node was measured to be in the 1 state in (e) and (i).

### BRIEF DESCRIPTION OF THE DRAWINGS

For a more complete understanding of the features and advantages of the present invention, reference is now made to the detailed description of the invention along with the accompanying figures, in which:

FIG. 1 is a block diagram of a quantum node in accordance with one embodiment of the present disclosure;

FIGS. 2A-2C are block diagrams showing one or more interior qubits arranged together in various non-limiting structures in accordance with one embodiment of the present disclosure;

FIG. 3 depicts a device mask and microscopic image for a three-qubit quantum node in accordance with one embodiment of the present disclosure;

FIG. 4 depicts a loss-resistant entanglement protocol between Node-1 and Node-3 in accordance with one embodiment of the present disclosure;

FIGS. 5A-5C are flow charts of the loss-resistant entanglement protocol between Node-1 and Node-3 in accordance with one embodiment of the present disclosure;

FIG. 6A is a protocol chart of a loss-resistant entanglement protocol between Node-1 and Node-2 in accordance with one embodiment of the present disclosure;

FIG. 6B is a plot of the click probability and entanglement fidelity for the loss-resistant entanglement protocol between Node-1 and Node-2 in accordance with one embodiment of the present disclosure.

FIG. 6C is a plot of the qubit decoherence limited fidelity for the loss-resistant entanglement protocol between Node-1 and Node-2 in accordance with one embodiment of the present disclosure.

FIGS. 7A-7B are flow charts of the loss-resistant entanglement protocol between Node-1 and Node-2 in accordance with one embodiment of the present disclosure;

FIG. 8 depicts a parametric photon exchange (SWAP) between a communication qubit of the quantum node and the communication resonators of two quantum nodes and the coaxial cable/coplanar waveguide in accordance with one embodiment of the present disclosure.

FIG. 9 depicts a method of fabricating a quantum node in accordance with one embodiment of the present disclosure;

FIG. 10 depicts a fabrication process in accordance with one embodiment of the present disclosure; and

FIGS. 11A-11C depict a method of fabricating a flip-chip quantum cluster on wafer in accordance with one embodiment of the present disclosure.

### DETAILED DESCRIPTION OF THE INVENTION

Illustrative embodiments of the system of the present application are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

It is desirable to create an experimental testbed for multi-node entanglement network protocols. Users can see the performance of their error resistant protocols in action on real quantum hardware in the near-term. The testbed is supposed to be versatile meaning that it is easily reconfigurable and scalable per the needs of users in a co-design way by combining the scalability of superconducting quantum processors and the extensibility of entanglement network. This should provide a unique opportunity for the distributed quantum information processing community.

Beyond the scope of being a testbed for advanced entanglement networking protocols, the combination of advanced superconducting quantum processors with high fidelity entanglement network enables the development of scalable distributed quantum computing architectures that power the next step in the evolution of the superconducting quantum computers. Like the classical high-performance-computing (HPC), processors cannot be arbitrarily scaled up by increasing the area of silicon due to rapidly decreasing uniformity and yields with area. This is particularly true for quantum processors since qubit quality can be detrimentally impacted by small imperfections and superconducting qubits have sub-mm footprints determined by the achievable inductance and capacitance density which does not allow Moore's law like miniaturization due to underlying microwave superconducting physics. As increasing qubit-count per standard size chip is ultimately limited and there is no such limitations to cryogenics, the future path for superconducting quantum computing will rely on distributed quantum computing within one low-temperature space like how HPC relies on distributed computing using a network of standard size CPUs. Furthermore, dedicated devices specialized in high-fidelity logics, long-time quantum memory, and future novel superconducting quantum computing platforms can be engineered as modular components and networked together via a local entanglement network.

In addition, quantum devices can have incompatible fabrication processes and even incompatible operation environment. However, incompatible devices can often offer unique capabilities that are not accessible using compatible technologies. For example, quantum microwave-optical transducers require processes that involve materials relatively lossy in microwave and operate with strong optical input that is detrimental to superconducting qubit coherence. However, such transducers provide the capability to entangle microwave quantum computing devices over a large distance via optical fiber, making the quantum internet with powerful superconducting quantum computers possible in the future. Local quantum entanglement network can allow high-fidelity transfer of quantum state between incompatible devices and incorporation of such transducers as quantum network cards to superconducting quantum computers.

In addition, the various embodiments described herein provide various features:

1. Parametric photon release that allows fast, high-fidelity, and controllable deterministic release and capture of microwave photons for creating loss-resistant entanglement via heralding.

2. Furthermore, these are all done using full-microwave control without noise sensitive DC controls and high attenuation of loss when photon release is not needed. Such microwave activated photon release allows release timing and photon waveform programming via room-temperature electronics.

3. Moreover, parametric photon release allows photon release into desired frequency bands that are determined and influence by fabrication and its randomness. This makes system fabrication yield robust as no precise cross-wafer device fabrication uniformity is needed.

4. The incorporation of wide bandwidth photon release filter (“communication resonator”) allows definition of communication channel for high efficiency photon exchange between quantum nodes. This photon release filter: (1) limits the noise propagating into the high-coherence nodes from the lossy RF cable connecting quantum nodes; (2) enhances the parametric photon release rate via resonance enhancement and modification to electromagnetic density of states of the communication channel; and (3) rejects the unwanted parametric sideband since the qubit can simultaneously release into two frequency bands if the channel has no photon release filter to define one communication band. This restriction significantly increases the photon release fidelity.

5. Scalable beyond two nodes as the architecture is self-similar and entanglement can be generated in a large multi-node entanglement network at high fidelity via concatenation.

6. The methods use heralding for loss-resistant entanglement generation between nodes connected via lossy RF cables or coplanar waveguides. Different from Reference #3 below, the heralding protocol is designed and implemented completely within quantum processing units (quantum nodes) without using separate RF single-photon-detector nodes and lossy RF beam-splitters. This simplification and innovation make the efficiency of entanglement generation higher by more than one order of magnitude and removed the stringent constraints in fabricating parameter matched narrow-band quantum processor nodes and single-photon-detector detector nodes.

7. The method is the only method combining the scalability of 2D (planar) quantum processor architecture (References 1 and 4) with heralding based loss-resistant microwave entanglement generation (Reference 3).

This architecture is the unavoidable enabler technology to enable the scaling of superconducting quantum computing technologies beyond the near-term stage into large-scale quantum computing cluster that can produce critical quantum computational power to solve and accelerate solving challenging computational tasks in designing new drugs, new materials, new chemicals, and cutting-edge quantum-enabled artificial intelligence which will significantly alter the future of computation industry as well as industries relying on it. This technology can be used to build cutting-edge industry leading quantum computers for disrupting the computing industry for many years.

Various embodiments described herein have numerous advantages, which may include, but are not limited to: (1) “Mature” and scalable technology for advanced quantum logics; (2) Based on established micro/nano-fabrication infrastructure for rapid fabrication and testing; (3) Straightforward and efficient programmable qubit-photon parametric transduction tailored to various protocols' requirements; and/or (4) Accessible (cloud) protocol testbed for users and direct application in distributed microwave quantum computing. Some embodiments may be limited to cryogenic space and interconnect with fiber-optical network using a quantum optic-microwave transducer.

Various non-limiting embodiments will now be described in more detail.

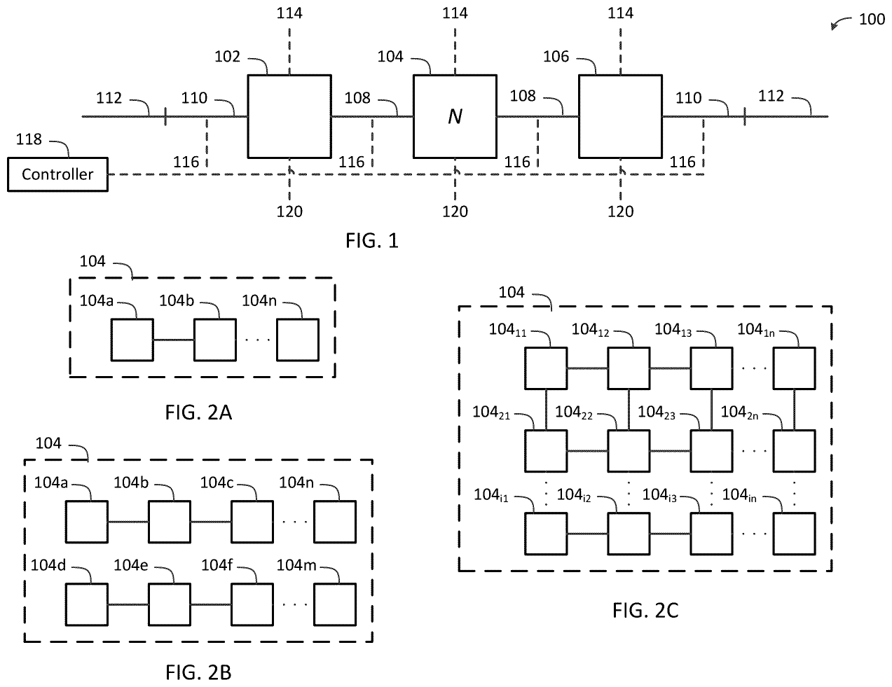

Now referring to FIG. 1, a block diagram of a quantum node 100 in accordance with one embodiment of the present disclosure is shown. In this example, the quantum node 100 includes two or more communication qubits 102, 106, one or more interior qubits 104 coupled between the two or more communication qubits 102, 106 with interior tunable couplers 108, a communication tunable coupler 110 coupled to each of the one or more communication qubits 102, 106, and a communication resonator 112 coupled to each of the communication tunable couplers 110. The two or more communication qubits 102, 106 and one or more interior qubits 104 can be, but are not required to be, identical to one another. Likewise, the interior tunable couplers 108 and the communication tunable couplers 110 can be, but are not required to be, identical to one another. The names merely denote the placement of the components within the quantum node. Moreover, there can be any number of interior qubits 104 as represented by the label “N” within the block. The one or more interior qubits 104 can be arranged together in any desired structure such as, but not limited to, a set of series connected qubits (FIG. 2A), a set of parallel connected qubits (FIG. 2B), an array of interconnected qubits (FIG. 2C), etc. Moreover, any of the interior qubits 104 may be connected to a communication tunable coupler 110, which is connected to a communication resonator 112. In such a case, the interior qubit 104 essentially becomes a communication qubit 102, 106. As a result, the quantum node 100 is configurable and scalable to satisfy any desired operating characteristics. In other embodiments, the quantum node includes one or more communication qubits and one or more interior qubits 104 coupled to the one or more communication qubits.

In addition, a readout resonator 114 is coupled to each of the one or more communication qubits 102, 106 and the one or more interior qubits 104. The readout resonator 114 may be used for projective measurement to implement heralding-based entanglement. A control connector 116 is coupled to each of the interior tunable couplers 108 and the communication tunable couplers 110. An alternating current or radio frequency (AC/RF) signal can be applied to the interior tunable coupler 108 or the communication tunable coupler 110 via the control connector 116 to cause parametric photon swap. A controller 118 can be coupled to the control connectors 116, wherein the controller 118 can operate at room temperature and generates the AC/RF signal. A drive connector 120 is coupled to each of the one or more communication qubits 102, 106 and the one or more interior qubits 104. Note that the drive connection 120 applies single-qubit operations on each qubit. For example, changing the stage of the qubit from 0→1 or 1→0 or 0→a superposition state like (|1>+|0>)/sqrt (2).

The communication resonators 112 (coupled with coaxial cable or coplanar waveguide modes) allow definition of a communication channel for high efficiency photon exchange between the quantum node 100 and other quantum nodes (not shown). Moreover, the communication resonators 112 enhance a parametric photon release rate via resonance enhancement and modification to an electromagnetic density of states of the communication channel. The two or more communication qubits 102, 106 and the one or more interior qubits 104 can simultaneously release into a frequency band in the communication channel. Moreover, the communication resonators 112 can limit noise from propagating into the quantum node 100 from a coaxial cable, coplanar waveguide or other type of suitable connector or waveguide (not shown) connected to the communication resonators 112. An effective loss of photon transfer into or out of the quantum node 100 can be reduced using a dark mode. A dark mode is a resonance or communication mode formed by the hybridization of two communication resonators and the coaxial-cable/coplanar waveguide or other connector/waveguide coupled to both of them. It is “dark” because it has minimal energy participation in the lossy coaxial-cable/coplanar waveguide region. The communication resonators 112 can also reject an unwanted parametric sideband during photon swap between a qubit and a communication resonator. Finally, the quantum node 100 does not require any radio-frequency single-photon-detector nodes or radio-frequency beam-splitters.

Referring now to FIGS. 2A-2C, block diagrams showing one or more interior qubits 104 arranged together in various non-limiting structures in accordance with one embodiment of the present disclosure are shown. FIG. 2A depicts a set of series connected qubits 104a, 104b, . . . , 104n. FIG. 2B depicts a set of parallel connected qubits 104a, 104b, 104c, . . . , 104n and 104d, 104e, 104f . . . , 104m. FIG. 2C depicts an array of interconnected qubits 104₁₁, 104₁₂, 104₁₃, . . . , 104₁ₙ and 104₂₁, 104₂₂, 104₂₃ . . . , 104ᵢₙ and 104ᵢ₁, 104ᵢ₂, 104ᵢ₃ . . . , 104ᵢₙ.

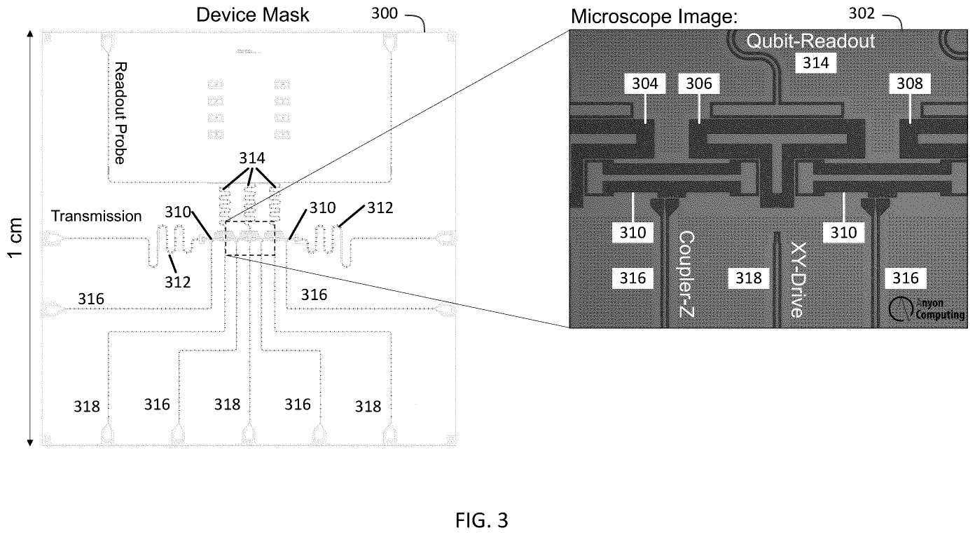

Now referring to FIG. 3, a device mask 300 and microscopic image 302 for a three-qubit quantum node, such as quantum node 100 in (FIG. 1) in accordance with one embodiment of the present disclosure are shown. The quantum node includes three qubits 304, 306, 308 that are coupled together in series with tunable couplers 310. A communication resonator 312 is coupled to each of the tunable couplers 310 that are connected to the exterior qubits 304, 308. The qubits 304, 306, 308 are identical to one another. Likewise, the tunable couplers 310 are identical to one another. A readout resonator (Qubit-Readout) 314 is coupled to each of the qubits 304, 306, 308 and is used to carry out projective measurement for implementing the heralding-based loss-resistant quantum entanglement generation as described below. A control connector (Coupler-Z) 316 is coupled to each of the tunable couplers 310 and is used to control the tunable couplers 310 between the qubits for two-qubit gate or between qubits and the communication resonators for parametric photon release or capture. A drive connector (XY-Drive) 318 is coupled to each of the qubits 304, 306, 308 and is used for carry out single qubit gate on the connected transmon qubit.

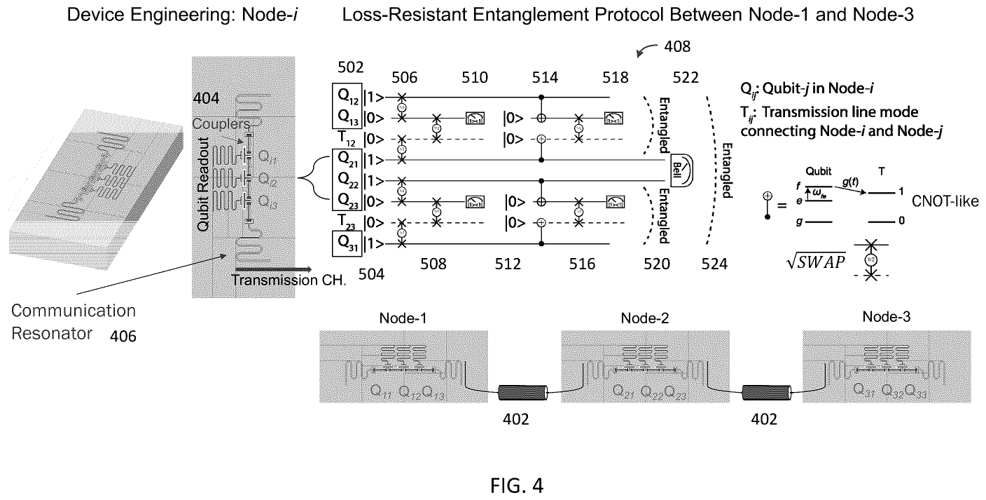

Referring now to FIG. 4, a loss-resistant entanglement protocol between Node-1 and Node-3 in accordance with one embodiment of the present disclosure is shown. This illustration only focuses on loss-resistant heralding-based entanglement generation and high-fidelity entanglement swap in a linear quantum network of three quatum nodes Node-1, Node-2, Node-3. The three superconducting quantum nodes Node-1, Node-2, Node-3 are substantially identical, and each contains three transmon qubits Qu wherein i represents the node number and j represents the qubit number. Note that the quantum nodes can be different from one another in other embodiments. The three quantum nodes Node-1, Node-2, Node-3 are connected to each other via coaxial cables 402 (illustrated as the red cylinder). The coaxial cables 402 are represented by Ti wherein the transmission line mode connects Node-i and Node-j. Coplanar waveguides can be used instead of the coaxial cables 402.

The three qubits in each node are indicated with the light-blue letter Q, and there are also four tunable couplers 404 that are used to generated two-qubit gates on-demand. There is also the on-chip coupling to the coaxial transmission line 402 (also referred to as coaxial cable) via the communication resonators 406. The qubit readout resonators are used for projective measurements that are needed for implementing the heralding-based entanglement generation.

This example is called a baseline because it is designed to demonstrate the basic functionalities needed to build scalable entanglement network with advanced quantum nodes and encoding. More complicated quantum processor nodes can be engineered by adding more transmon qubits since only three qubit each nodes are needed for generate entanglement via lossy cables with heralding. More nodes can be added since the entanglement generation and swap can be concatenated together to create a large multi-node entanglement network.

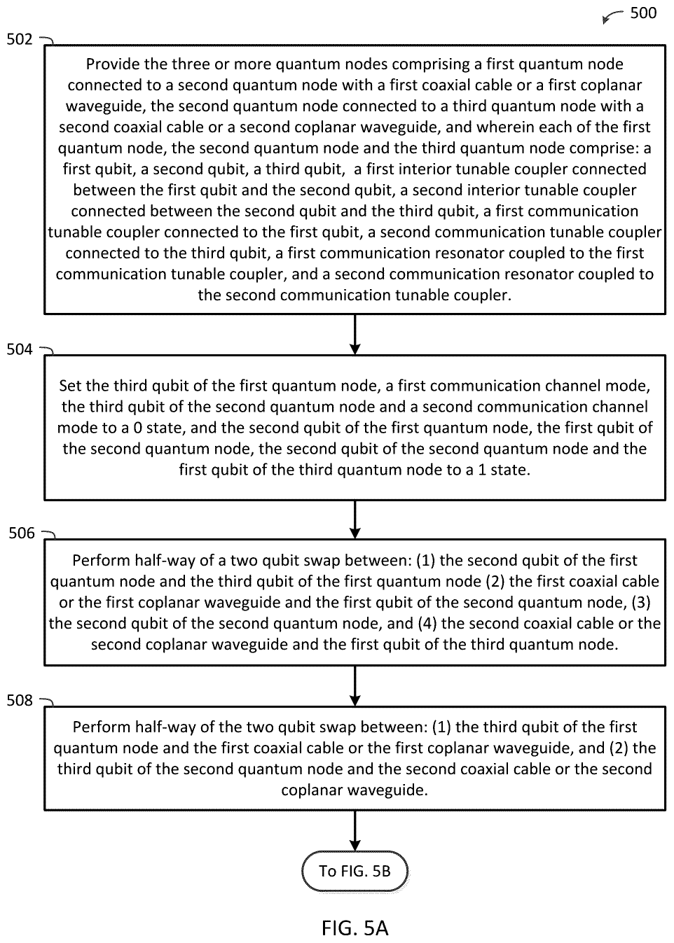

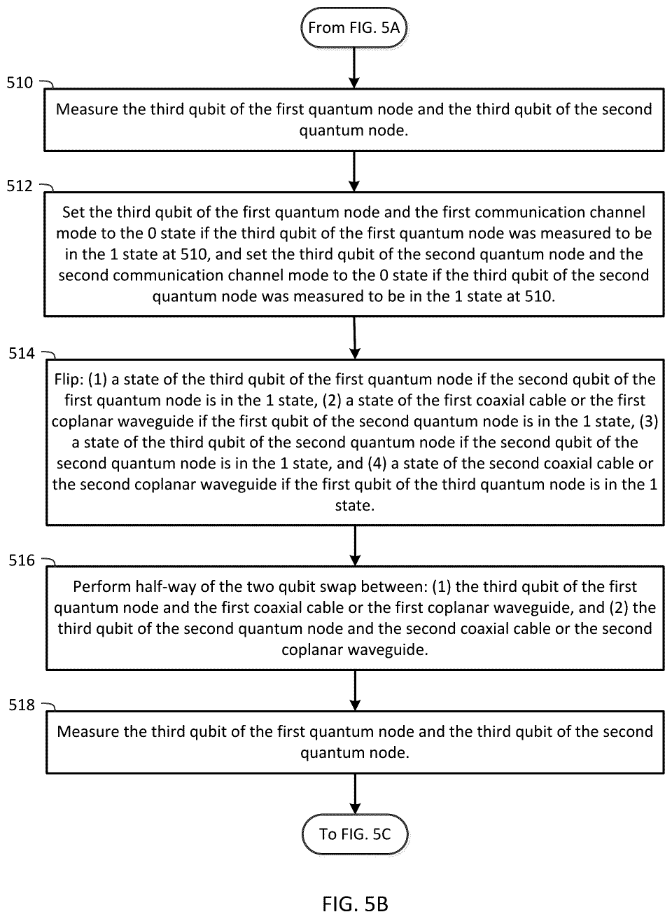

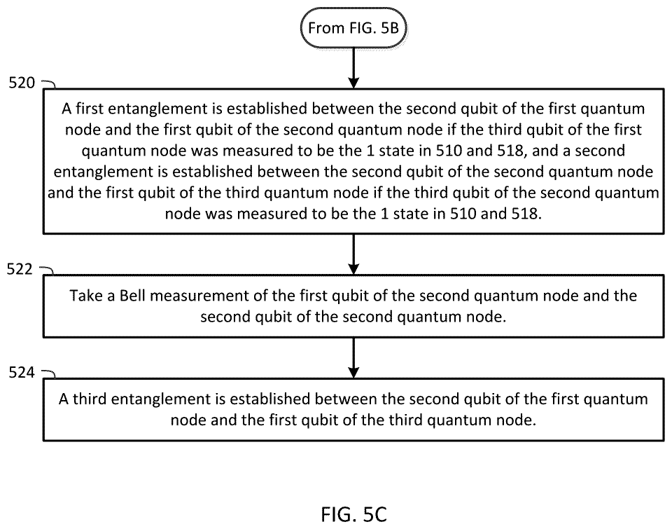

Now referring both to the protocol chart 408 of FIG. 4 and the flow chart 500 of FIGS. 5A-5C, the loss-resistant entanglement protocol between Node-1 and Node-3 in accordance with one embodiment of the present disclosure will be described. The three or more quantum nodes are provided at 502. The three or more quantum nodes include a first quantum node connected to a second quantum node with a first coaxial cable or a first coplanar waveguide, the second quantum node connected to a third quantum node with a second coaxial cable or a second coplanar waveguide, and wherein each of the first quantum node, the second quantum node and the third quantum node comprise: a first qubit, a second qubit, a third qubit, a first interior tunable coupler connected between the first qubit and the second qubit, a second interior tunable coupler connected between the second qubit and the third qubit, a first communication tunable coupler connected to the first qubit, a second communication tunable coupler connected to the third qubit, a first communication resonator coupled to the first communication tunable coupler, and a second communication resonator coupled to the second communication tunable coupler. As used herein, coaxial cables or coplanar waveguides can also refer to other types of suitable connectors or waveguides.

At 504, the third qubit of the first quantum node, a first communication channel mode (formed by the hybridization of the second communication resonator of the first quantum node, first communication resonator of the second quantum node, and the first coaxial cable or the first coplanar waveguide), the third qubit of the second quantum node and a second communication channel mode (formed by the hybridization of the second communication resonator of the second quantum node, first communication resonator of the third quantum node, and the second coaxial cable or the second coplanar waveguide) are set to a 0 state, and the second qubit of the first quantum node, the first qubit of the second quantum node, the second qubit of the second quantum node and the first qubit of the third quantum node are set to a 1 state.

At 506, half-way of a two qubit swap is performed between: (1) the second qubit of the first quantum node and the third qubit of the first quantum node (2) the first coaxial cable or the first coplanar waveguide and the first qubit of the second quantum node, (3) the second qubit of the second quantum node, and (4) the second coaxial cable or the second coplanar waveguide and the first qubit of the third quantum node.

At 508, half-way of the two qubit swap is performed between: (1) the third qubit of the first quantum node and the first coaxial cable or the first coplanar waveguide, and (2) the third qubit of the second quantum node and the second coaxial cable or the second coplanar waveguide or.

At 510, the third qubit of the first quantum node and the third qubit of the second quantum node are measured.

At 512, the third qubit of the first quantum node and the first communication channel mode (formed by the hybridization of the second communication resonator of the first quantum node, first communication resonator of the second quantum node, and the first coaxial cable or the first coplanar waveguide) are set to the 0 state if the third qubit of the first quantum node was measured to be in the 1 state at 510, and the third qubit of the second quantum node and the second communication channel mode (formed by the hybridization of the second communication resonator of the second quantum node, first communication resonator of the third quantum node, and the second coaxial cable or the second coplanar waveguide) are set to the 0 state if the third qubit of the second quantum node was measured to be in the 1 state at 510.

At 514, flipping: (1) a state of the third qubit of the first quantum node if the second qubit of the first quantum node is in the 1 state, (2) a state of the first coaxial cable or the first coplanar waveguide if the first qubit of the second quantum node is in the 1 state, (3) a state of the third qubit of the second quantum node if the second qubit of the second quantum node is in the 1 state, and (4) a state of the second coaxial cable or the second coplanar waveguide if the first qubit of the third quantum node is in the 1 state. Note that these are actually quantum controlled-NOT gates (CNOT), which are blind (i.e., no observation of the qubit state should happen to determine if a flip (NOT) operation happens). The quantum nature of the gate means it happens as a natural observation-free intrinsic quantum process.

At 516, half-way of the two qubit swap is performed between: (1) the third qubit of the first quantum node and the first coaxial cable or the first coplanar waveguide, and (2) the third qubit of the second quantum node and the second coaxial cable or the second coplanar waveguide.

At 518, the third qubit of the first quantum node and the third qubit of the second quantum node are measured.

At 520, a first entanglement is established between the second qubit of the first quantum node and the first qubit of the second quantum node if the third qubit of the first quantum node was measured to be the 1 state in 510 and 518, and a second entanglement is established between the second qubit of the second quantum node and the first qubit of the third quantum node if the third qubit of the second quantum node is measured to be the 1 state in 510 and 518.

At 522, a Bell measurement is taken of the first qubit of the second quantum node and the second qubit of the second quantum node.

At 524, a third entanglement is established between the second qubit of the first quantum node and the first qubit of the third quantum node.

The quantum entanglement needs both 510 and 518 to measure the third qubit of the first quantum node and the third qubit of the second quantum node in the 1 state. In fact, if 510 does not measure the third qubit of the first quantum node and the third qubit of the second quantum node in the 1 state, the protocol could be re-run from 504 until 510 produces the 1 state measurements after which the protocol can continue to reset relevant states in 512. Similarly, if 518 does not measure the third qubit of the first quantum node and the third qubit of the second quantum node in the 1 state, the protocol could be re-run from 504 until 510 and 518 produce the 1 state measurements after which the first and second entanglements are established in 520. For example, step 512 further comprises repeating steps 502, 504, 506 and 508 until the third qubit of the first quantum node was measured to be in the 1 state in step 510. In another example, step 518 further comprises repeating 502, 504, 506, 508, 510, 512, 514 and 516 until the third qubit of the first quantum node was measured to be in the 1 state in steps 512 and 518.

Alternatively, the protocol could be run from 504 to 524 multiple rounds without real-time feedforward controls and post-select results of rounds where 510 and 518 produce the 1 state measurements after which the first and second entanglements are established in 520. Note that this sequence is less efficient than the sequences with real-time feedforward controls described in the previous paragraph.

The fundamental reason for repeating the sequence until the measurements produce the desired outcomes in a correct order (hence the name “heralding”) for generating the entanglement is that the system quantum states are engineered to be in the so-called superposition of several possible outcomes simultaneously and measurements non-deterministically produce (“project onto”) one of the possible outcomes. Only the correct time-ordered outcomes “project” the quantum system into a desired quantum entangled state.

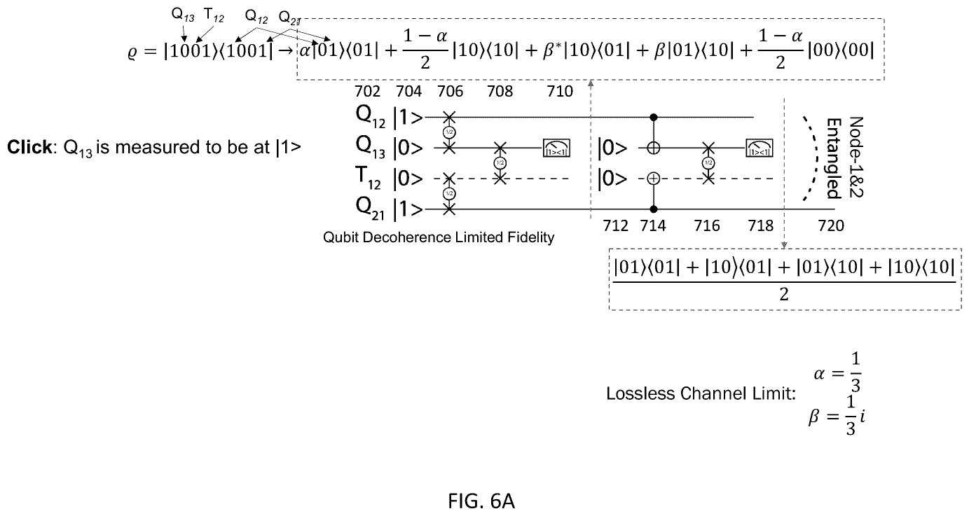

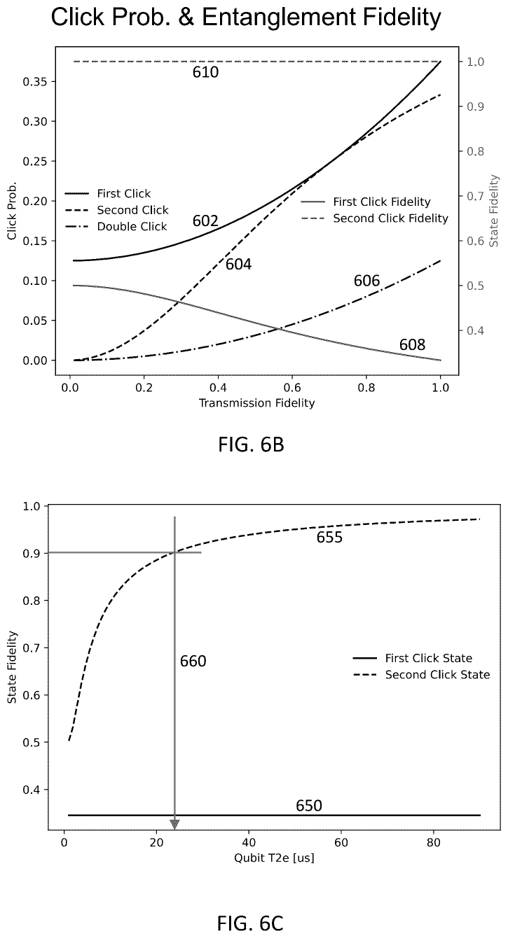

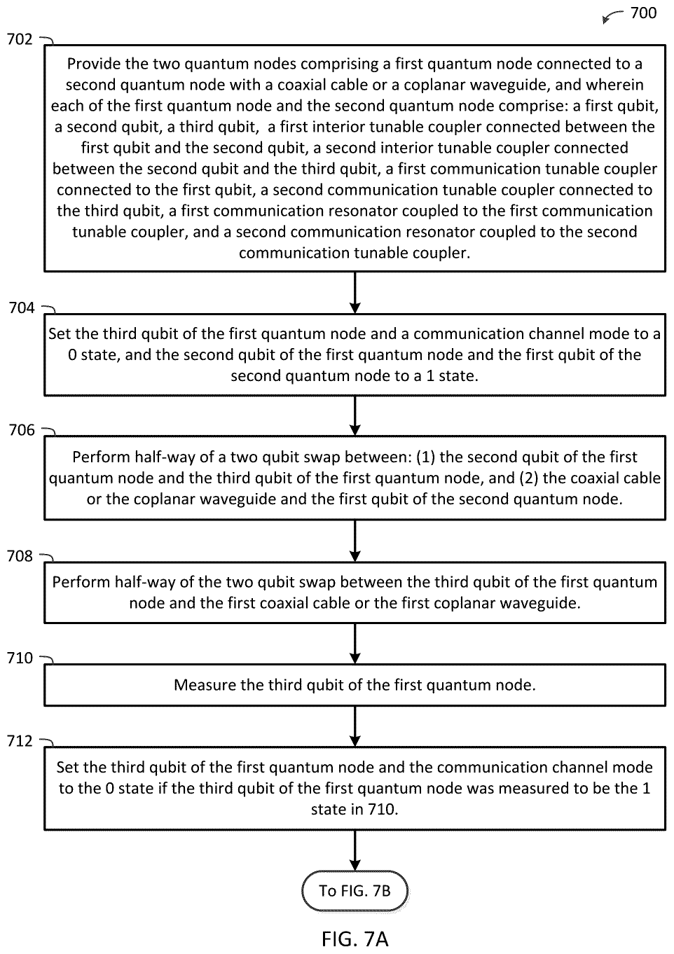

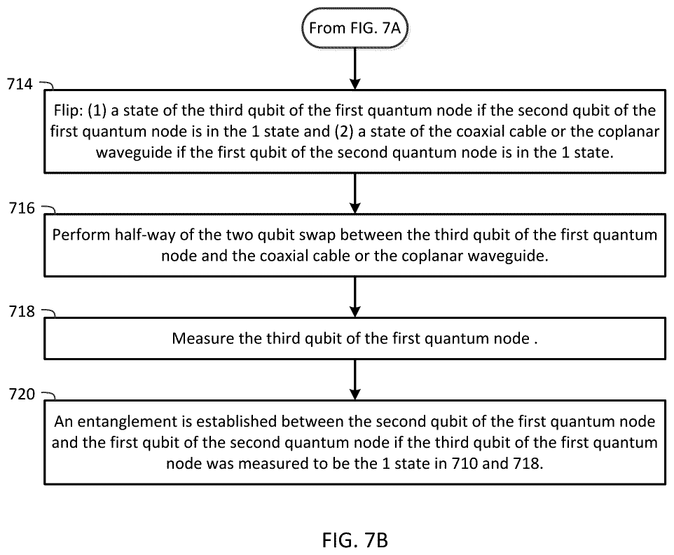

Referring now to the protocol chart FIG. 6A and the flow chart 700 of FIGS. 7A-7B, the loss-resistant entanglement protocol between Node-1 and Node-2 in accordance with one embodiment of the present disclosure will be described. The two quantum nodes are provided at 702. The two quantum nodes include a first quantum node connected to a second quantum node with a coaxial cable or a coplanar waveguide, and wherein each of the first quantum node and the second quantum node comprise: a first qubit, a second qubit, a third qubit, a first interior tunable coupler connected between the first qubit and the second qubit, a second interior tunable coupler connected between the second qubit and the third qubit, a first communication tunable coupler connected to the first qubit, a second communication tunable coupler connected to the third qubit, a first communication resonator coupled to the first communication tunable coupler, and a second communication resonator coupled to the second communication tunable coupler. As used herein, coaxial cables or coplanar waveguides can also refer to other types of suitable connectors or waveguides.

At 704, the third qubit of the first quantum node and a communication channel mode (formed by hybridization of the second communication resonator of the first quantum node, the first communication resonator of the second quantum node, and the coaxial cable or the coplanar waveguide) are set to a 0 state, and the second qubit of the first quantum node and the first qubit of the second quantum node are set to a 1 state.

At 706, half-way of a two qubit swap is performed between: (1) the second qubit of the first quantum node and the third qubit of the first quantum node, and (2) the coaxial cable or the coplanar waveguide and the first qubit of the second quantum node.

At 708, half-way of the two qubit swap is performed between the third qubit of the first quantum node the coaxial cable or the coplanar waveguide.

At 710, the third qubit of the first quantum node is measured.

At 712, the third qubit of the first quantum node and the communication channel mode (formed by hybridization of the second communication resonator of the first quantum node, the first communication resonator of the second quantum node, and the coaxial cable or the coplanar waveguide) are set to the 0 state if the third qubit of the first quantum node was measured to be in the 1 state in 710.

At 714, flipping: (1) a state of the third qubit of the first quantum node if the second qubit of the first quantum node is in the 1 state, and (2) a state of the coaxial cable or the coplanar waveguide if the first qubit of the second quantum node is in the 1 state. Note that these are actually quantum controlled-NOT gates (CNOT), which are blind (i.e., no observation of the qubit state should happen to determine if a flip (NOT) operation happens). The quantum nature of the gate means it happens as a natural observation-free intrinsic quantum process.

At 716, half-way of the two qubit swap is performed between the third qubit of the first quantum node and the coaxial cable or the first coplanar waveguide.

At 718, the third qubit of the first quantum node is measured.

At 720, an entanglement is established between the second qubit of the first quantum node and the first qubit of the second quantum node if the third qubit of the first quantum node was measured to be in the 1 state in 710 and 718.

The quantum entanglement needs both 710 and 718 to measure the third qubit of the first quantum in the 1 state. In fact, if 710 does not measure the third qubit of the first quantum node in the 1 state, the protocol could be re-run from 704 until 710 produces the 1 state measurement after which the protocol can continue to reset relevant states in 712. Similarly, if 718 does not measure the third qubit of the first quantum node in the 1 state, the protocol could be re-run from 704 until 710 and 718 produce the 1 state measurement after which the entanglement is established in 720. For example, step 712 further comprises repeating steps 702, 704, 706 and 708 until the third qubit of the first quantum node was measured to be in the 1 state in step 710. In another example, step 718 further comprises repeating 702, 704, 706, 708, 710, 712, 714 and 716 until the third qubit of the first quantum node was measured to be in the 1 state in steps 712 and 718.

Alternatively, the protocol could be run from 704 to 720 multiple rounds without real-time feedforward controls and post-select results of rounds where 710 and 718 produce the 1 state measurement after which the entanglement is established in 720. Note that this sequence is less efficient than the sequences with real-time feedforward controls described in the previous paragraph.

FIG. 6B is a plot of the click probability and entanglement fidelity for the loss-resistant entanglement protocol between Node-1 and Node-2 in accordance with one embodiment of the present disclosure. Now also referring to FIGS. 7A-7B, success of loss-resistant entanglement protocol step 710 is the First Click 602 (solid black line), and success of loss-resistant entanglement protocol step 718 is the Second Click 604 (dashed black line). Success of the two steps 710 and 718 in one sequence of execution is Double Click 606 (dash-dot black line), which is the flag of a successful sequence from beginning to end to entangle Node-1 and Node-2. The First Click Fidelity 608 (solid blue line) and Second Click Fidelity 610 (dashed blue line) are also shown.

FIG. 6C is a plot of the qubit decoherence limited fidelity for the loss-resistant entanglement protocol between Node-1 and Node-2 in accordance with one embodiment of the present disclosure. The First Click State 650 (solid black line), Second Click State 655 (dashed black line), and the intersection of the Second Click State 655 at a State Fidelity of 0.9 depicted as lines 660 (solid blue lines) are shown.

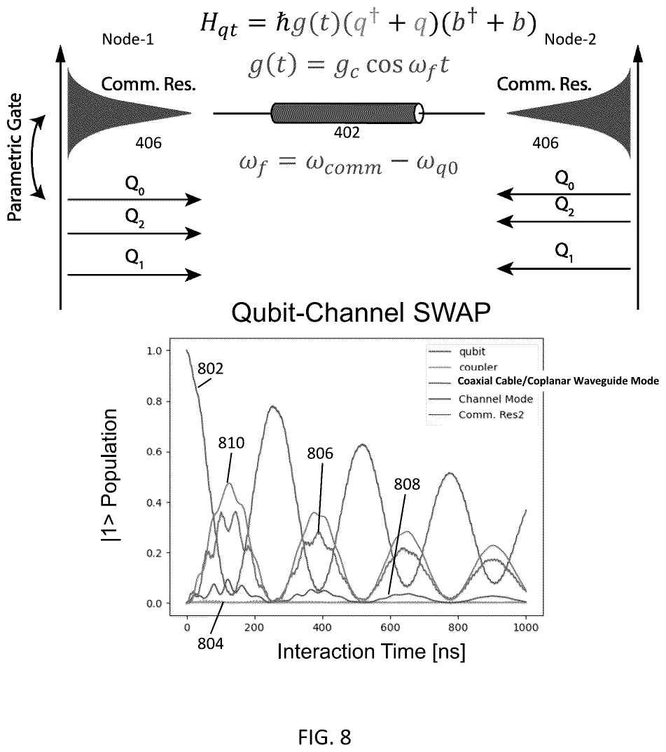

FIG. 8 depicts a photon exchange (SWAP) between a communication qubit of one quantum node and the communication resonators of two quantum nodes Node-1, Node-2 and the coaxial cable/coplanar waveguide 402 in accordance with one embodiment of the present disclosure. Q₀, Q₁ and Q₂ are the qubits in quantum nodes Node-1, Node-1. Line 802 (blue line) is the qubit, line 804 (orange line) is the coupler, line 806 (green line) is the first communication resonator, line 808 (red line) is the coaxial cable/coplanar waveguide mode, and line 810 (purple line) is the second communication resonator.

Now referring back to FIGS. 1, 3 and 4, a distributed quantum computing system in accordance with one embodiment of the present disclosure will be described. The distributed quantum computing system includes two or more quantum nodes Node-1, . . . , Node-N, wherein each quantum node Node-1, . . . , Node-N includes one or more communication qubits 102, 106, one or more interior qubits 104 coupled to the one or more communication qubits 102, 106 with interior tunable couplers 108, a communication tunable coupler 110 coupled to each of the one or more communication qubits 102, 106, and a communication resonator 112 coupled to each of the communication tunable couplers 110. One or more coaxial cables or coplanar waveguides 402 connect the two or more quantum nodes Node-1, . . . , Node-N together using at least one of the communication resonators 112 of the two or more quantum nodes Node-1, . . . , Node-N. The two or more quantum nodes Node-1, . . . , Node-N can be different or substantially identical to one another. Moreover, the two or more quantum nodes Node-1, . . . , Node-N can be superconducting quantum nodes. An effective loss of photon transfer into or out of the two or more quantum nodes Node-1, . . . , Node-N is reduced using a dark mode. The system is scalable.

The one or more communication qubits 102, 106 and one or more interior qubits 104 are identical to one another. Likewise, the interior tunable couplers 108 and the communication tunable couplers 110 are identical to one another. The names merely denote the placement of the components within the quantum node. Moreover, there can be any number of interior qubits 104 as represented by the label “N” within the block. The one or more interior qubits 104 can be arranged together in any desired structure such as, but not limited to, a set of series connected qubits (FIG. 2A), a set of parallel connected qubits (FIG. 2B), an array of interconnected qubits (FIG. 2C), etc. Moreover, any of the interior qubits 104 may be connected to a communication tunable coupler 110, which is connected to a communication resonator 112. As a result, the quantum node 100 is configurable and scalable to satisfy any desired operating characteristics.

In addition, a readout resonator 114 is coupled to each of the two or more communication qubits 102, 106 and the one or more interior qubits 104. The readout resonator 114 may be used for projective measurement to implement heralding-based entanglement. A control connector 116 is coupled to each of the interior tunable couplers 108 and the communication tunable couplers 110. An AC/RF signal can be applied to the interior tunable coupler 108 or the communication tunable coupler 110 via the control connector 116 to cause parametric photon swap. A controller 118 can be coupled to the control connectors 116, wherein the controller 118 can operate at room temperature and generates the AC/RF signal. A drive connector 120 is coupled to each of the one or more communication qubits 102, 106 and the one or more interior qubits 104.

The communication resonators 112 allow definition of a communication channel for high efficiency photon exchange between the quantum node 100 and other quantum nodes (not shown). Moreover, the communication resonators 112 enhance a parametric photon release rate via resonance enhancement and modification to an electromagnetic density of states of the communication channel. The two or more communication qubits 102, 106 and the one or more interior qubits 104 can simultaneously release into a frequency band in the communication channel. Moreover, the communication resonators 112 can limit noise from propagating into the quantum node 100 from a coaxial cable or coplanar waveguide (not shown) connected to the communication resonators 112. An effective loss of photon transfer into or out of the quantum node 100 can be reduced using a dark mode. The communication resonators can also reject an unwanted parametric sideband. Finally, the quantum node 100 does not require any radio-frequency single-photon-detector nodes or radio-frequency beam-splitters.

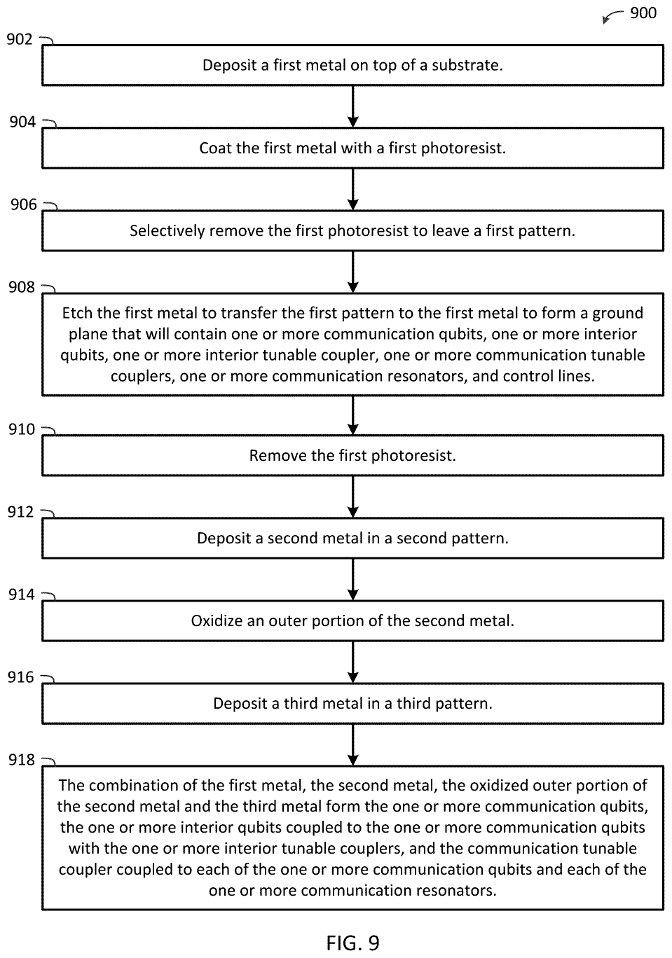

Now referring to FIG. 9, a method 900 of fabricating a quantum node in accordance with one embodiment of the present disclosure is shown. A first metal is deposited on a top of a substrate in block 902, the first metal is coated with a first photoresist in block 904, and the first photoresist is selectively removed to leave a first pattern in block 906. The first metal is etched to transfer the first pattern to the first metal to form a ground plane and one or more communication resonators in block 908, and the first photoresist is removed in block 910. A second metal is deposited in a second pattern in block 912, an outer portion of the second metal is oxidized in block 914, and a third metal is deposited in a third pattern in block 916. The combination of the first metal, the second metal, the oxidized outer portion of the second metal and the third metal form one or more communication qubits, one or more interior qubits coupled to the one or more communication qubits with interior tunable couplers, and a communication tunable coupler coupled to each of the one or more communication qubits and each of the one or more communication resonators in block 918. The first metal can be, but is not limited to aluminum, niobium, tantalum or other superconducting metal. The second and third metal can be, but is not limited to aluminum or other superconducting metal. Other steps may include: fabricating a wiring wafer containing control lines and co-planar wave, and bonding the wiring wafer to the quantum node; or bonding the wiring wafer to a printed circuit board.

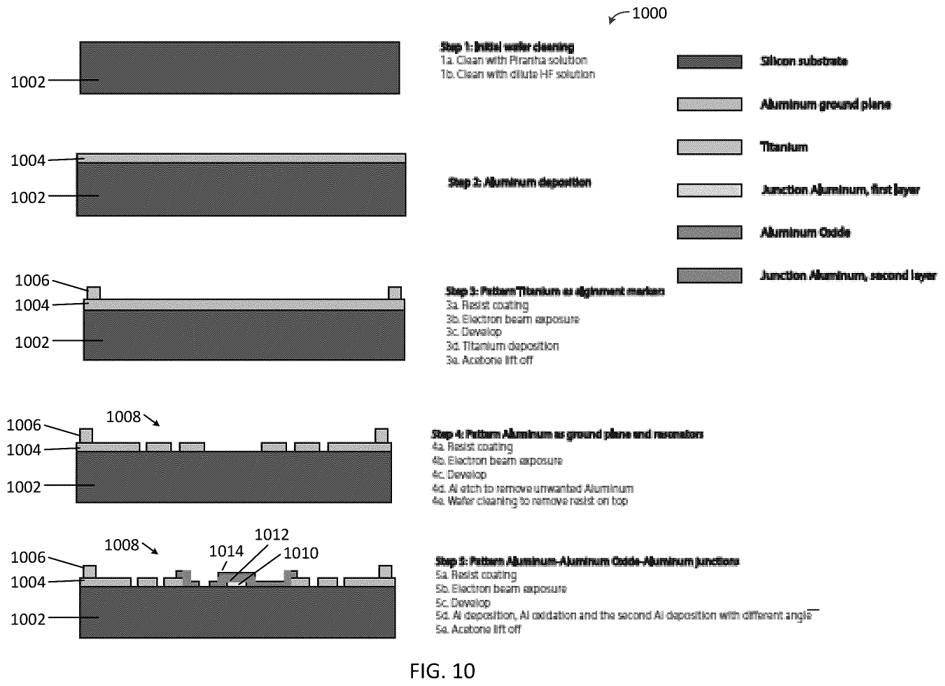

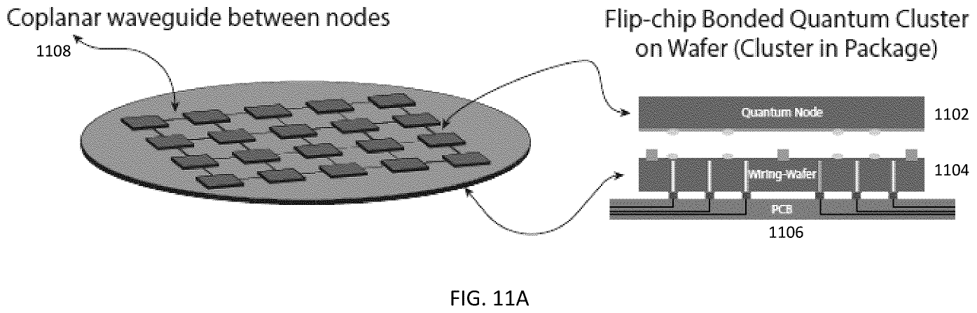

Referring now to FIG. 10, a fabrication process 1000 in accordance with one embodiment of the present disclosure is shown. Note that the aluminum can be niobium, tantalum or other superconducting metal.

Step 1: Initial wafer cleaning of the silicon substrate 1002 (black): (1a) clean with Piranha solution and (1b) clean with dilute HF solution.

Step 2: Deposit an aluminum ground plane 1004 (orange) on the silicon substrate 1002.

Step 3: Pattern titanium 1006 (gray) as alignment markers on the ground plane 1004: (3a) resist coating, (3b) electron beam exposures, (3c) develop, (3d) titanium deposition, and (3e) acetone lift off.

Step 4: Pattern the aluminum ground plane 1004 and resonators: (4a) resist coating, (4b) electron beam exposure, (4c) develop, (4d) aluminum etch to remove unwanted aluminum, and (4) after cleaning to remove resist on top. The ground plane 1004 will contain one or more communication qubits, one or more interior qubits, one or more interior tunable couplers, one or more communication tunable couplers, one or more communication resonators, and control lines (collectively 1808).

Step 5: Pattern aluminum, aluminum oxide and aluminum junctions: (5a) resist coating, (5b) electron beam exposure, (5c) develop, (5d) first aluminum deposition 1010 (yellow), aluminum oxidation 1012 (blue) and the second aluminum deposition 1014 (red) with different angle, and (5e) acetone lift off. The combination of the first metal, the second metal, the oxidized outer portion of the second metal and the third metal form the one or more communication qubits, the one or more interior qubits coupled to the one or more communication qubits with the one or more interior tunable couplers, and the communication tunable coupler coupled to each of the one or more communication qubits and each of the one or more communication resonators.

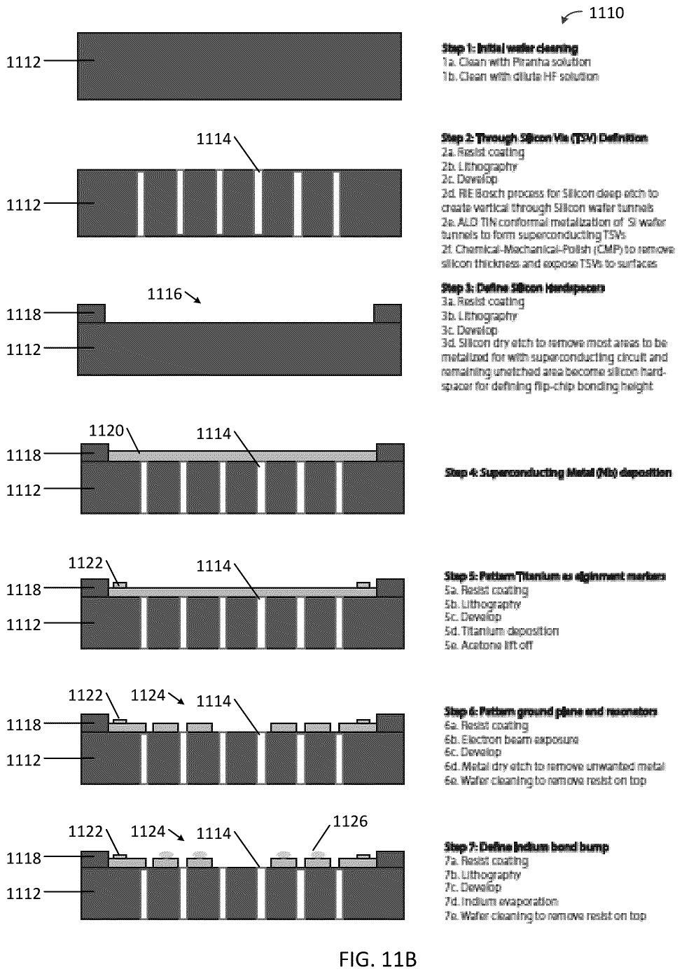

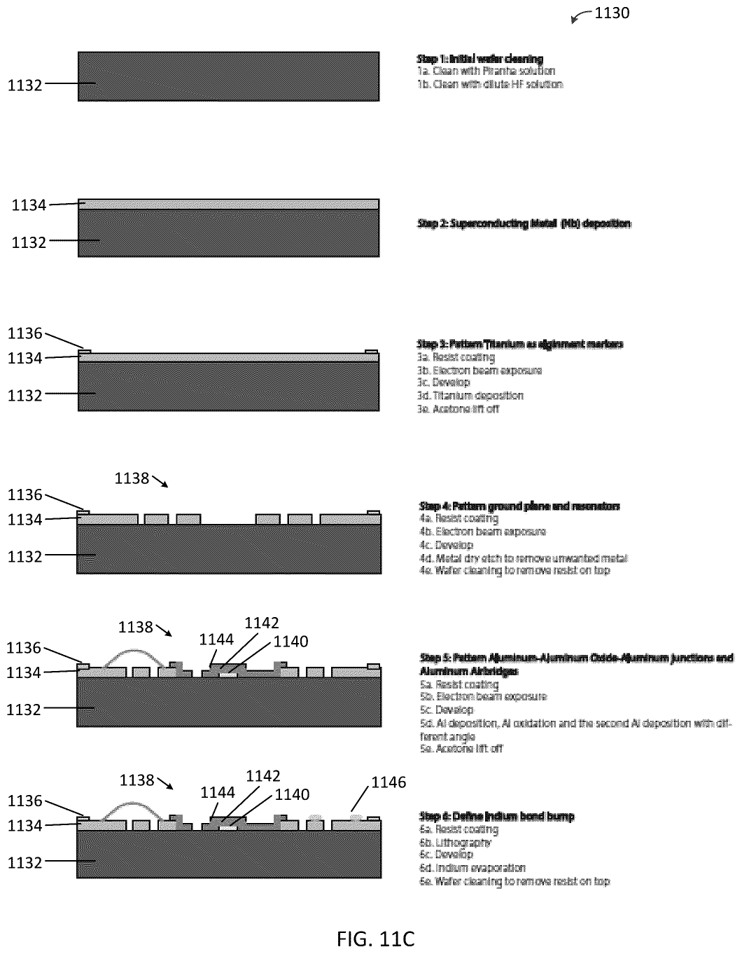

Now referring to FIGS. 11A-11C, a method of fabricating a flip-chip quantum cluster on wafer in accordance with one embodiment of the present disclosure is shown. Each quantum node 1102 is bonded to a wiring wafer 1104, which in turn is connected to a PCB board 1106. The quantum nodes 1102 are connected together with coplanar waveguides 1108. The wiring wafer 1104 contains the necessary control lines and coplanar waveguides forming the communication channel with communication resonators in the quantum nodes. Note that the aluminum can be niobium, tantalum or other superconducting metal. The wiring wafer 1104 processing steps 1110 are illustrated in FIG. 11B:

Step 1: Initial wafer cleaning of the silicon substrate 1112 (black): (la) clean with Piranha solution and (1b) clean with dilute HF solution.

Step 2: Through silicon via (TSV) definition: (2a) resist coating, (2b) lithography, (2c) develop, (2d) RIE Bosch process for silicon deep etch to create vertical through silicon wafer tunnels 1114, (2e) ALD TiN conformal metalization of the silicon wafer tunnels to form superconduction TSVs (PECVD Al and other suitable materials may also be used), and (2f) chemical-mechanical-polish (CMP) to remove silicon thickness and expose TSVs to surfaces.

Step 3: Define silicon hardspaces: (3a) resist coating, (3b) lithography, (3c) develop, (3d) silicon dry etch to remove most areas 1116 to be metalized with superconducting circuit and remaining unetched area become silicon hard spacer 1108 for defining flip-chip bonding height.

Step 4: Deposit superconducting metal (Nb) 1110 in area 1116 between the hard spacers 1118.

Step 5: Pattern titanium as alignment markers 1122: (5a) resist coating, (5b) lithography, (5c) develop, (5d) titanium deposition, and (5e) acetone lift off.

Step 6: Pattern ground plane and resonators 1124: (6a) resist coating, (6b) electron beam exposure, (6c) develop, (6d) metal dry etch to removed unwanted metal, and (6e) after cleaning to remove resist on top.

Step 7: Define indium bond bumps 1126: (7a) resist coating, (7b) lithography, (7c) develop, (7d) indium evaporation, and (7e) wafer cleaning to remove resist on top.

The quantum node 1102 processing steps 1130 are illustrated in FIG. 11C:

Step 1: Initial wafer cleaning of the silicon substrate 1132 (black): (la) clean with Piranha solution and (1b) clean with dilute HF solution.

Step 2: Deposit superconducting metal (Nb) 1134 (orange) on the silicon substrate 1132.

Step 3: Pattern titanium as alignment markers 1136 (gray): (3a) resist coating, (3b) electron beam exposures, (3c) develop, (3d) titanium deposition, and (3e) acetone lift off.

Step 4: Pattern ground plane and resonators 1138 (orange): (4a) resist coating, (4b) electron beam exposure, (4c) develop, (4d) metal dry etch to remove unwanted metal, and (4) wafer cleaning to remove resist on top.

Step 5: Pattern aluminum, aluminum oxide and aluminum junctions: (5a) resist coating, (5b) electron beam exposure, (5c) develop, (5d) first aluminum deposition 1140 (yellow), aluminum oxidation 1142 (blue) and the second aluminum deposition 1144 (red) different angle, and (5e) acetone lift off.

Step 6: Define indium bond bumps 1146 (light gray): (6a) resist coating, (6b) lithography, (6c) develop, (6d) indium evaporation, and (6e) wafer cleaning to remove resist on top.

Circuits can be implemented with, but are not limited to, single or combinations of discrete electrical and electronic components, integrated circuits, semiconductor devices, analog devices, digital devices, etc. Elements can be coupled together using any type of suitable direct or indirect connection between the elements including, but not limited to, wires, pathways, channels, vias, electromagnetic induction, electrostatic charges, optical links, wireless communication links, etc.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. In embodiments of any of the compositions and methods provided herein, “comprising” may be replaced with “consisting essentially of” or “consisting of.” As used herein, the phrase “consisting essentially of” requires the specified integer(s) or steps as well as those that do not materially affect the character or function of the claimed invention. As used herein, the term “consisting” is used to indicate the presence of the recited integer (e.g., a feature, an element, a characteristic, a property, a method/process step, or a limitation) or group of integers (e.g., feature(s), element(s), characteristic(s), property(ies), method/process(s) steps, or limitation(s)) only.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

As used herein, words of approximation such as, without limitation, “about,” “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skill in the art recognize the modified feature as still having the required characteristics and capabilities of the unmodified feature. In general, but subject to the preceding discussion, a numerical value herein that is modified by a word of approximation such as “about” may vary from the stated value by at least ±1, 2, 3, 4, 5, 6, 7, 10, 12 or 15%.

All of the devices and/or methods disclosed and claimed herein can be made and executed without undue experimentation in light of the present disclosure. While the devices and/or methods of this invention have been described in terms of particular embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope, and concept of the invention as defined by the appended claims.

Furthermore, no limitations are intended to the details of construction or design herein shown, other than as described in the claims below. It is therefore evident that the particular embodiments disclosed above may be altered or modified and all such variations are considered within the scope and spirit of the disclosure. Accordingly, the protection sought herein is as set forth in the claims below.

Modifications, additions, or omissions may be made to the systems and apparatuses described herein without departing from the scope of the invention. The components of the systems and apparatuses may be integrated or separated. Moreover, the operations of the systems and apparatuses may be performed by more, fewer, or other components. The methods may include more, fewer, or other steps. Additionally, steps may be performed in any suitable order.

To aid the Patent Office, and any readers of any patent issued on this application in interpreting the claims appended hereto, applicants wish to note that they do not intend any of the appended claims to invoke 35 U.S.C. § 112 (f) as it exists on the date of filing hereof unless the words “means for” or “step for” are explicitly used in the particular claim.

### REFERENCES

1. Y Zhong, A. N. Cleland et al., Nature 590, 571-575 (2021).
2. C. Axline, M. H. Devoret, R. J. Schoelkopf et al., Nature Phys 14, 705-710 (2018).
3. A. Narla, M. H. Devoret, R. J. Schoelkopf et al., PRX 6, 031036 (2016).
4. N. Leung, Y. Lu, and D. I. Schuster et al., npj Quantum Inf 5, 18 (2019).

What is claimed is:

1. A quantum node comprising:
one or more communication qubits;
one or more interior qubits coupled to the one or more communication qubits with interior tunable couplers;
a communication tunable coupler coupled to each of the one or more communication qubits; and
a communication resonator coupled to each of the communication tunable couplers.

2. The quantum node of claim 1, wherein the one or more interior qubits comprise a set of series connected qubits, a set of parallel connected qubits, or an array of interconnected qubits.

3. The quantum node of claim 1, further comprising a readout resonator coupled to each of the one or more communication qubits and the one or more interior qubits.

4. The quantum node of claim 3, wherein the readout resonator is used for projective measurement to implement heralding-based entanglement.

5. The quantum node of claim 1, further comprising a control connector coupled to each of the interior tunable couplers and the communication tunable couplers.

6. The quantum node of claim 5, wherein an alternating current or radio frequency (AC/RF) signal is applied to the interior tunable coupler or the communication tunable coupler via the control connector to cause parametric photon swap.

7. The quantum node of claim 6, further comprising a controller coupled to the control connector, wherein the controller generates the AC/RF signal.

8. The quantum node of claim 1, further comprising a drive connector coupled to each of the one or more communication qubits and the one or more interior qubits.

9. The quantum node of claim 1, wherein the communication resonator allows definition of a communication channel for high efficiency photon exchange between the quantum node and other quantum nodes.

10. The quantum node of claim 9, wherein the communication resonator enhances a parametric photon release rate via resonance enhancement and modification to an electromagnetic density of states of the communication channel.

11. The quantum node of claim 9, wherein the one or more communication qubits simultaneously release into a frequency band in the communication channel.

12. The quantum node of claim 1, wherein the communication resonator limits noise from propagating into the quantum node from a coaxial cable or coplanar waveguide.

13. The quantum node of claim 1, wherein an effective loss of photon transfer into or out of the quantum node is reduced using a dark mode.

14. The quantum node of claim 1, wherein the communication resonator rejects an unwanted parametric sideband.

15. The quantum node of claim 1, wherein the quantum node does not require any radio-frequency single-photon-detector nodes or radio-frequency beam-splitters.

16. A distributed quantum computing system comprising:
two or more quantum nodes, wherein each quantum node comprises:
one or more communication qubits,
one or more interior qubits coupled to the one or more communication qubits with interior tunable couplers,
a communication tunable coupler coupled to each of the one or more communication qubits, and
a communication resonator coupled to each of the communication tunable couplers; and
one or more coaxial cables or coplanar waveguides connecting the two or more quantum nodes together using at least one of the communication resonators of the two or more quantum nodes.

17. The distributed quantum computing system of claim 16, wherein the two or more quantum nodes are different or substantially identical to one another.

18. The distributed quantum computing system of claim 16, wherein the two or more quantum nodes are superconducting quantum nodes.

19. The distributed quantum computing system of claim 16, wherein the one or more interior qubits comprise a set of series connected qubits, a set of parallel connected qubits, or an array of interconnected qubits.

20. The distributed quantum computing system of claim 16, further comprising a readout resonator coupled to each of the one or more communication qubits and the one or more interior qubits.

21. The distributed quantum computing system of claim 20, wherein the readout resonator is used for projective measurement to implement heralding-based entanglement.

22. The distributed quantum computing system of claim 16, further comprising a control connector coupled to each of the interior tunable couplers and the communication tunable couplers.

23. The distributed quantum computing system of claim 22, wherein an AC/RF signal is applied to the interior tunable coupler or the communication tunable coupler via the control connector to cause parametric photon swap.

24. The distributed quantum computing system of claim 23, further comprising a controller coupled to the control connector, wherein the controller generates the AC/RF signal.

25. The distributed quantum computing system of claim 16, further comprising a drive connector coupled to each of the one or more communication qubits and the one or more interior qubits.

26. The distributed quantum computing system of claim 16, wherein the communication resonator allows definition of a communication channel for high efficiency photon exchange between the quantum node and other quantum nodes.

27. The distributed quantum computing system of claim 26, wherein the communication resonator enhances a parametric photon release rate via resonance enhancement and modification to an electromagnetic density of states of the communication channel.

28. The distributed quantum computing system of claim 26, wherein the one or more communication qubits simultaneously release into a frequency band in the communication channel.

29. The distributed quantum computing system of claim 16, wherein the communication resonator limits noise from propagating into the two or more quantum nodes from the coaxial cable or coplanar waveguide.

30. The distributed quantum computing system of claim 16, wherein an effective loss of photon transfer into or out of the two or more quantum nodes is reduced using a dark mode.

31. The distributed quantum computing system of claim 16, wherein the communication resonator rejects an unwanted parametric sideband.

32. The distributed quantum computing system of claim 16, wherein the system does not require any radio-frequency single-photon-detector nodes or radio-frequency beam-splitters.

33. The distributed quantum computing system of claim 16, wherein the system is scalable.

34. A method of fabricating a quantum node comprising:
depositing a first metal on a top of a substrate;
coating the first metal with a first photoresist;
selectively removing the first photoresist to leave a first pattern;
etching the first metal to transfer the first pattern to the first metal to form a ground plane that will contain one or more communication qubits, one or more interior qubits, one or more interior tunable couplers, one or more communication tunable couplers, one or more communication resonators, and control lines;
removing the first photoresist;
depositing a second metal in a second pattern;
oxidizing an outer portion of the second metal;
depositing a third metal in a third pattern; and
wherein the combination of the first metal, the second metal, the oxidized outer portion of the second metal and the third metal form the one or more communication qubits, the one or more interior qubits coupled to the one or more communication qubits with the one or more interior tunable couplers, and the communication tunable coupler coupled to each of the one or more communication qubits and each of the one or more communication resonators.

35. The method of claim 34, wherein:
the first metal comprises aluminum, niobium or tantalum; and
the second and third metal comprise aluminum.

36. The method of claim 34, further comprising:
fabricating a wiring wafer containing control lines and co-planar waveguides; and
bonding the wiring wafer to the quantum node.

37. The method of claim 36, further comprising bonding the wiring wafer to a printed circuit board.

38. A loss-resistant entanglement protocol for three or more quantum nodes comprising:
(a) providing the three or more quantum nodes comprising a first quantum node connected to a second quantum node with a first coaxial cable or a first coplanar waveguide, the second quantum node connected to a third quantum node with a second coaxial cable or a second coplanar waveguide, and wherein each of the first quantum node, the second quantum node and the third quantum node comprise: a first qubit, a second qubit, a third qubit, a first interior tunable coupler connected between the first qubit and the second qubit, a second interior tunable coupler connected between the second qubit and the third qubit, a first communication tunable coupler connected to the first qubit, a second communication tunable coupler connected to the third qubit, a first communication resonator coupled to the first communication tunable coupler, and a second communication resonator coupled to the second communication tunable coupler;
(b) setting the third qubit of the first quantum node, a first communication channel mode, the third qubit of the second quantum node and a second communication channel mode to a 0 state, and the second qubit of the first quantum node, the first qubit of the second quantum node, the second qubit of the second quantum node and the first qubit of the third quantum node to a 1 state;
(c) performing half-way of a two qubit swap between: (1) the second qubit of the first quantum node and the third qubit of the first quantum node, (2) the first coaxial cable or the first coplanar waveguide and the first qubit of the second quantum node, (3) the second qubit of the second quantum node, and (4) the second coaxial cable or the second coplanar waveguide and the first qubit of the third quantum node;
(d) performing half-way of the two qubit swap between: (1) the third qubit of the first quantum node and the first coaxial cable or the first coplanar waveguide, and (2) the third qubit of the second quantum node and the second coaxial cable or the second coplanar waveguide;
(e) measuring the third qubit of the first quantum node and the third qubit of the second quantum node;
(f) setting the third qubit of the first quantum node and the first communication channel mode to the 0 state if the third qubit of the first quantum node was measured to be in the 1 state, and setting the third qubit of the second quantum node and the second communication channel mode to the 0 state if the third qubit of the second quantum node was measured to be in the 1 state;
(g) flipping: (1) a state of the third qubit of the first quantum node if the second qubit of the first quantum node is in the 1 state, (2) a state of the first coaxial cable or the first coplanar waveguide if the first qubit of the second quantum node is in the 1 state, (3) a state of the third qubit of the second quantum node if the second qubit of the second quantum node is in the 1 state, and (4) a state of the second coaxial cable or the second coplanar waveguide if the first qubit of the third quantum node is in the 1 state;
(h) performing half-way of the two qubit swap between: (1) the third qubit of the first quantum node and the first coaxial cable or the first coplanar waveguide, and (2) the third qubit of the second quantum node and the second coaxial cable or the second coplanar waveguide;
(i) measuring the third qubit of the first quantum node and the third qubit of the second quantum node;
(j) wherein a first entanglement is established between the second qubit of the first quantum node and the first qubit of the second quantum node if the third qubit of the first quantum node was measured to be in the 1 state, and a second entanglement is established between the second qubit of the second quantum node and the first qubit of the third quantum node if the third qubit of the second quantum node was measured to be in the 1 state;
(k) taking a Bell measurement of the first qubit of the second quantum node and the second qubit of the second quantum node; and
(l) wherein a third entanglement is established between the second qubit of the first quantum node and the first qubit of the third quantum node.

39. The loss-resistant entanglement protocol of claim 38, wherein (f) further comprises repeating (b), (c), (d) and (e) until the third qubit of the first quantum node and the third qubit of the second quantum node were measured to be in the 1 state in (e).

40. The loss-resistant entanglement protocol of claim 38, wherein (j) further comprises repeating (b), (c), (d), (e), (f), (g), (h) and (i) until the third qubit of the first quantum node and the third qubit of the second quantum node were measured to be in the 1 state in (e) and (i).

41. A loss-resistant entanglement protocol for two quantum nodes comprising:
(a) providing the two quantum nodes comprising a first quantum node connected to a second quantum node with a coaxial cable or a coplanar waveguide, and wherein each of the first quantum node and the second quantum node comprise: a first qubit, a second qubit, a third qubit, a first interior tunable coupler connected between the first qubit and the second qubit, a second interior tunable coupler connected between the second qubit and the third qubit, a first communication tunable coupler connected to the first qubit, a second communication tunable coupler connected to the third qubit, a first communication resonator coupled to the first communication tunable coupler, and a second communication resonator coupled to the second communication tunable coupler;
(b) setting the third qubit of the first quantum node and a communication channel mode to a 0 state, and the second qubit of the first quantum node and the first qubit of the second quantum node to a 1 state;
(c) performing half-way of a two qubit swap between: (1) the second qubit of the first quantum node and the third qubit of the first quantum node, and (2) the coaxial cable or the coplanar waveguide and the first qubit of the second quantum node;
(d) performing half-way of the two qubit swap between the third qubit of the first quantum node and the coaxial cable or first coplanar waveguide;
(e) measuring the third qubit of the first quantum node;
(f) setting the third qubit of the first quantum node and the communication channel mode to the 0 state if the third qubit of the first quantum node was measured to be in the 1 state;
(g) flipping: (1) a state of the third qubit of the first quantum node if the second qubit of the first quantum node is in the 1 state and (2) a state of the coaxial cable or the coplanar waveguide if the first qubit of the second quantum node is in the 1 state;
(h) performing half-way of the two qubit swap between the third qubit of the first quantum node and the coaxial cable or the coplanar waveguide;
(i) measuring the third qubit of the first quantum node; and
(j) wherein an entanglement is established between the second qubit of the first quantum node and the first qubit of the second quantum node if the third qubit of the first quantum node was measured to be in the 1 state.

42. The loss-resistant entanglement protocol of claim 41, wherein (f) further comprises repeating (b), (c), (d) and (e) until the third qubit of the first quantum node was measured to be in the 1 state in (e).

43. The loss-resistant entanglement protocol of claim 41, wherein (j) further comprises repeating (b), (c), (d), (e), (f), (g), (h) and (i) until the third qubit of the first quantum node was measured to be in the 1 state in (e) and (i).
